(19) United States
(12) Patent Application Publication
(10) Pub. No.: US 2026/0015876 A1
(43) Pub. Date: Jan. 15, 2026

(54) COUPLING ELEMENTS AND SYSTEMS

(71) Applicant: 3form, LLC, Salt Lake City, UT (US)

(72) Inventors: Edwin A. Vice, JR., Seattle, WA (US); Bryce C. Anderson, Renton, WA (US)

(21) Appl. No.: 19/064,505

(22) Filed: Feb. 26, 2025

Related U.S. Application Data
(63) Continuation-in-part of application No. 29/951,874, filed on Jul. 11, 2024.

(51) Int. Cl. E04G 17/00; F16B 21/02

(52) U.S. Cl. CPC E04G 17/00; F16B 21/02

(57) ABSTRACT

This disclosure relates to coupling elements, coupling systems, and their methods of assembly and/or installation. The coupling elements can facilitate secure and tool-less connections, enabling panels and baffles to be mounted to walls, ceilings, or other structures in linear, angled, or curved configurations. The disclosure provides for the coupling of a baffle to a coupling element, a coupling element to a strut, and a strut to a surface.

### CROSS-REFERENCE TO RELATED APPLICATIONS

This application is a Continuation in Part to, and incorporates by reference in its entirety, U.S. Design patent application Ser. No. 29/951,874, filed on Jul. 11, 2024, and entitled “COUPLING ELEMENT.”

### BACKGROUND OF THE INVENTION

### 1. Technical Field

This disclosure relates to coupling elements used in the assembly of aesthetic and architectural panels and baffles.

### 2. Background and Relevant Art

Architectural panels and baffles are widely used in commercial, residential, and industrial settings for both functional and aesthetic purposes. These elements may be installed on walls, ceilings, or other surfaces to improve acoustics, enhance visual appeal, or provide structural separation. Conventional systems for mounting panels and baffles often involve rigid or semi-permanent fasteners, such as screws, brackets, or adhesives, which may limit design flexibility, complicate installation, or create challenges in achieving a seamless or refined appearance.

In some instances, conventional coupling mechanisms may lack the adaptability needed to accommodate varying panel sizes, shapes, or orientations, potentially hindering their use in complex architectural designs. Furthermore, systems relying on multiple discrete components may increase the time and labor required for assembly, while also raising the likelihood of misalignment or mechanical failure. In environments where panels are subject to frequent changes or reconfigurations, such as modular office spaces or exhibition venues, these limitations can be particularly problematic.

Additionally, some mounting systems may struggle to provide adequate structural support while maintaining an aesthetically clean finish, particularly when used for overhead installations like ceiling-mounted baffles. This can lead to a compromise between functionality and design appeal.

Accordingly, there are a number of disadvantages in the art that can be addressed.

### BRIEF SUMMARY OF THE INVENTION

Implementations of the present invention comprise systems, components, and methods corresponding to coupling elements and baffle coupling systems. Coupling elements and baffle coupling systems can be integrated into existing strut-based hardware or installed as a new functional or aesthetic structure.

For example, a coupling element can comprise a first upper contact surface and a second upper contact surface, a first lower contact surface and a second lower contact surface, and a receiving slot defined by a first arm having a first aperture and a second arm having a second aperture. In an embodiment, the first upper contact surface and the first lower contact surface define a first channel. The second upper contact surface and the second lower contact surface can also define a second channel.

In addition, a couplable baffle can comprise a coupling element comprises a receiving slot defined by a first arm having a first aperture and a second arm having a second aperture, a baffle having a first index and an opening, and a fastener having a first member selectively couplable with a second member. The receiving slot can be configured to interface with the first index. The baffle can be configured to recess within the receiving slot. The fastener can be configured to pass through the first aperture, the second aperture, and the opening to secure the baffle to the coupling element.

Furthermore, a baffle coupling system can comprise one or more coupling elements, one or more baffles, one or more struts. In an embodiment, a first of the one or more coupling elements can selectively and rotatably secure to a first of the one or more struts. The first coupling element can selectively couples to a first of the one or more baffles. The first strut can be coupled to a surface (e.g., floor, ceiling, roof, support, etc).

Still further, a method for installing a baffle coupling system can include a first act of inserting a first coupling element (that can be oriented about 90 degrees off of a locked orientation) into a space defined by the arms of a strut. A second act can include rotating the first coupling element (about 90 degrees) about a vertical axis into a locked orientation to secure the coupling element within the strut. A third act can include inserting a first end of a baffle into a receiving slot defined by a first and second arm of the first coupling element. A fourth act can include inserting a first half of a fastener into a first aperture in the first arm, an opening in the baffle, and a second aperture in the second arm. A fifth act can include inserting a second half of the fastener into the second aperture in the second arm, the opening in the baffle, and the first aperture in the first arm. A sixth act can include coupling the first half of the fastener and the second half of the fastener together.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a coupling system of the present disclosure;

FIG. 2A illustrates a perspective view of a coupling element of the present disclosure;

FIG. 2B illustrates a side view of a coupling element of the present disclosure;

FIG. 2C illustrates another side view of a coupling element of the present disclosure;

FIG. 3A illustrates a perspective view of a coupling element of the present disclosure;

FIG. 3B illustrates an exploded view of a coupling element of the present disclosure;

FIG. 4 illustrates a fastener of the present disclosure;

FIG. 5A illustrates a strut of the present disclosure;

FIG. 5B illustrates a strut and coupling element of the present disclosure;

FIG. 5C illustrates a coupling element of the present disclosure into a strut;

FIG. 5D illustrates a coupling element of the present disclosure secured to a strut;

FIG. 6A illustrates a coupling element secured to a strut in proximity to a baffle of the present disclosure;

FIG. 6B illustrates a coupling element secured to a strut where a baffle is inserted into the coupling element;

FIG. 6C illustrates the insertion of a fastener of the present disclosure;

FIG. 6D illustrates a baffle secured to a coupling element of the present disclosure;

FIG. 7 illustrates a baffle of the present disclosure;

FIG. 8A illustrates the bending or folding of a baffle of the present disclosure;

FIG. 8B illustrates the insertion of a puck of the present disclosure;

FIG. 8C illustrates an angled baffle of the present disclosure; and

FIG. 9 illustrates various pucks of the present disclosure.

### DETAILED DESCRIPTION OF THE PREFERRED EMBODIMENTS

The present disclosure extends to systems, components, and methods corresponding to coupling elements and baffle coupling systems. Coupling elements and baffle coupling systems can be integrated into existing strut-based hardware or installed as a new functional or aesthetic structure. Coupling elements that can comprise a first upper contact surface and a second upper contact surface, a first lower contact surface and a second lower contact surface, and a receiving slot defined by a first arm having a first aperture and a second arm having a second aperture. In an embodiment, the first upper contact surface and the first lower contact surface define a first channel. The second upper contact surface and the second lower contact surface can also define a second channel.

The coupling elements of the present disclosure are designed to facilitate an economical, quick, and easy installation of one or more baffles or panels that can be aesthetic and/or functional. The coupling elements of the present disclosure can be installed into an existing strut system, such as a conventional uni-strut system, without needing tools. These coupling elements can be injection-molded or additive-manufactured monolithic elements, allowing them to be cheaper than conventional securing hardware that would be used to secure a baffle or panel in place. Additionally, assemblers of systems of the present disclosure will appreciate the ease of installation of these systems as there can be less permanent anchoring needed when compared to conventional baffle and panel mounting solutions.

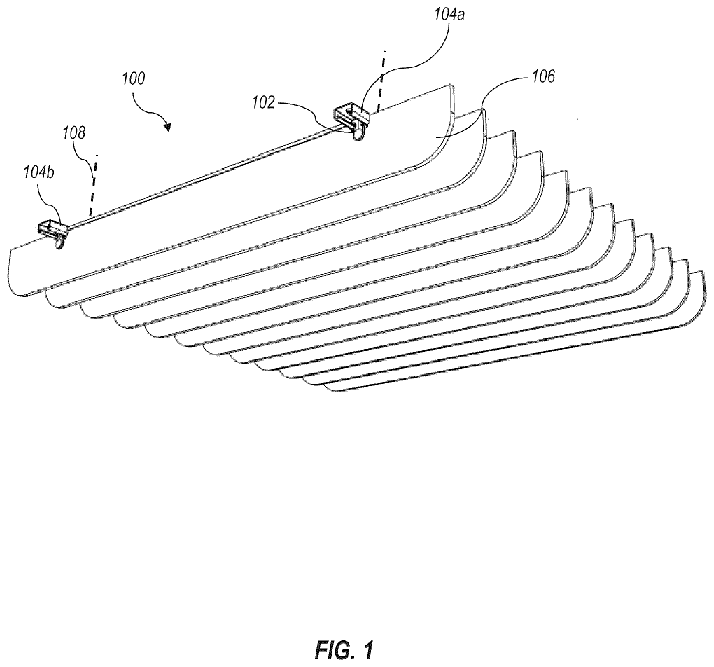

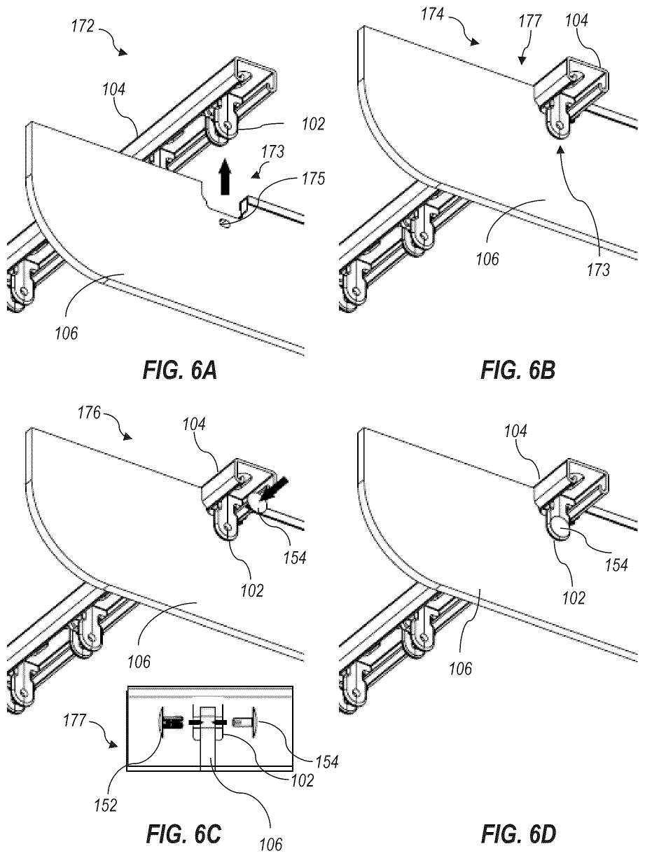

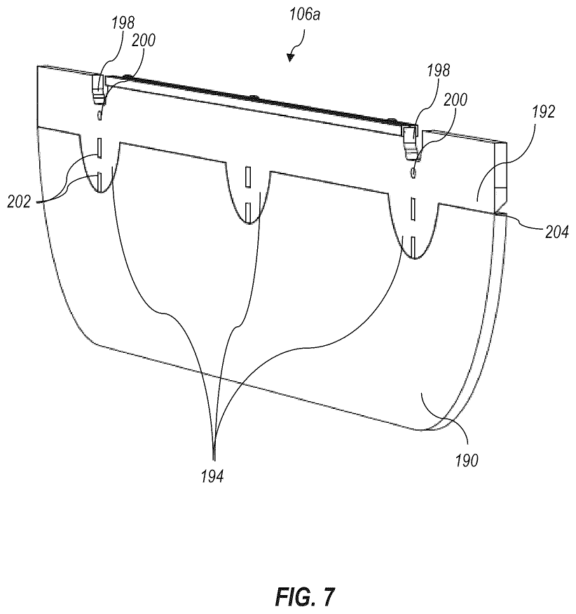

FIG. 1 illustrates coupling system 100. As shown, coupling system 100 can include one or more coupling elements 102, one or more struts 104a and 104b, one or more baffles 106, and one or more cables 108 (shown in phantom lines). Coupling system 100 can be secured directly to a ceiling, or to a ceiling using one or more cables 108, as illustrated. For example, an assembler can install two cables to each of the struts 104, i.e. securing one cable 108 near the first end of the strut and another cable 108 near the opposing second end of the strut. The assembler can then level or selectively angle the strut to a desired angle. The assembler can then secure or anchor a second strut 104b similar to the first strut 104a, ensuring they are positioned at a distance that corresponds to the indexes (see FIG. 6A or 7) of the desired baffles. In at least one embodiment, an assembler can install the struts so they are vertical or non-horizontal in their overall orientation.

FIG. 1 shows twelve baffles 106 secured to the two struts 104a and 104b. An assembler can install more or less than twelve baffles for every two struts, depending on the length of the struts and the spacing between the baffles.

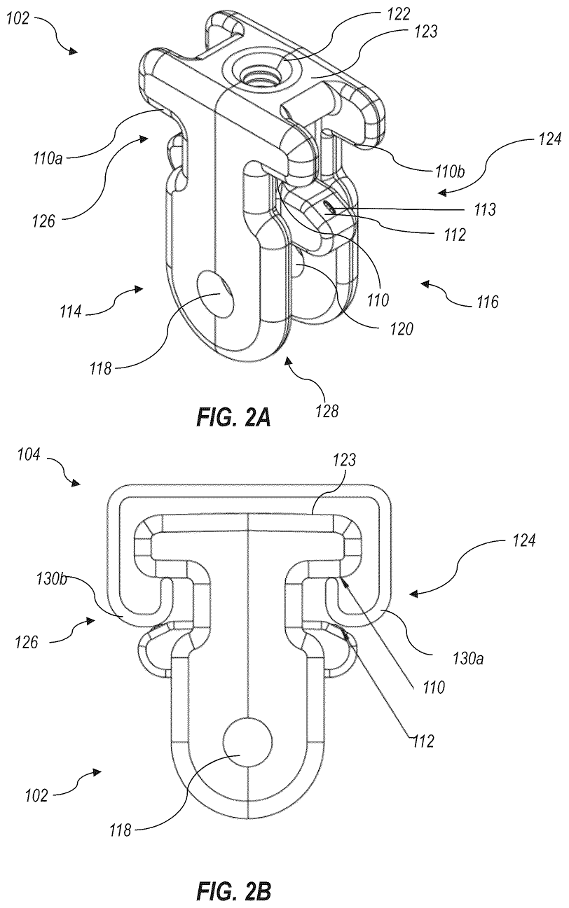

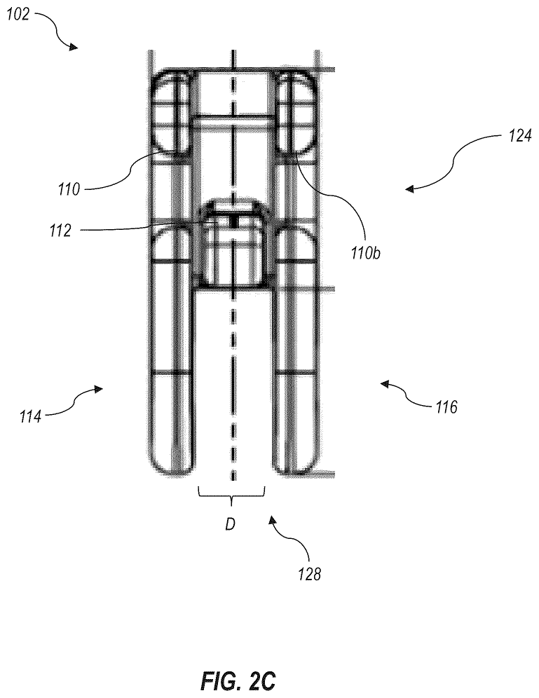

FIGS. 2A and 2B illustrate coupling element 102. Specifically, FIG. 2A illustrates an injection-molded embodiment of a coupling element. Coupling element 102 can have a first 110, second 110a, third 110b, and fourth (not visible) upper contact surfaces and a first 112 and second (not visible) lower contact surfaces. In at least one embodiment, each lower contact surface can have a ridge 113 disposed on its surface that is semi-deformable and included to increase the mounting force between a coupling element and a strut when locked into place.

The first and third upper contact surfaces (110 and 110b) and the first lower contact surface 112 can define a first channel 124. First channel 124 can receive a portion or arm of a strut (see FIG. 2B) in order to secure the coupling element 102 to the strut 104. Accordingly, the second and fourth upper contact surfaces (110a and not shown) and the second contact surface (not visible) can define a second channel 126. Second channel 126 can receive a portion or arm of the same strut (see FIG. 2B).

Coupling element 102 can have a first arm 114 having a first aperture 118 and a second arm 116 having a second aperture 120. FIG. 2A shows first arm 114 and second arm 116 extending down and away from the top surface 123. First arm 114 and second arm 116 can be substantially parallel. First arm 114 and second arm 116 have a distance between each other, and this distance can define a receiving slot 128.

FIG. 2A shows that coupling element 102 has a top surface of 123, which defines an opening to connector 122. Connector 122 can be a threaded cavity for receiving a threaded screw, bolt, or similar. An assembler can connect an anchoring cable directly to connector 122 in a given embodiment. An assembler can also lock coupling element 102 to a strut and then use connector 122 to anchor the coupling element and strut to a cable or surface.

FIG. 2B illustrates a side aspect view of coupling element 102. FIG. 2B also shows coupling element 102 interfacing with strut 104. Specifically, arm 130a is received into channel 124, and arm 130b is received into channel 126. To stay retained within the channels, a portion of arm 130a abuts the first upper contact surface 110, and a lower portion of arm 130a abuts the first lower contact surface 112. A similar interaction is had regarding channel 124 and arm 130b. Though not seen in FIG. 2B, arm 130a also can abut the third upper contact surface 110b (shown in FIG. 2A). FIG. 2B also shows that top surface 123 can be received within strut 104.

FIG. 2B shows coupling element 102 in a secured position. Once in this secured position, an assembler can still slide coupling element 102 along the length of strut 104, but in some cases, they need to exert some force to overcome the friction fit between coupling element 102 and strut 104. The ability to slide allows an assembler to adjust the position of each coupling element relative to the strut they are coupled with, even after attaching a baffle (i.e., in instances where rotating and uncoupling the coupling element would be difficult).

FIG. 2C illustrates another side view of a coupling element of the present disclosure. The distance (D) between the first arm 114 and the second arm 116 can be seen. This distance (D) can define the thickness of the baffle that coupling element 102 can couple to. Distance (D) can range from about 1 mm to 12 mm. For example, about 1 mm, about 2 mm, about 3 mm, about 4 mm, about 5 mm, about 6 mm, about 7 mm, about 8 mm, about 9 mm, about 10 mm, about 11 mm, or about 12 mm. In at least one embodiment, distance (D) can be greater than 12 mm. FIG. 2C also shows that the first upper contact surface 110 can be separate and distinct from the third upper contact surface 110b. This can be caused by an indentation in the body of coupling element 102 between these two contact surfaces.

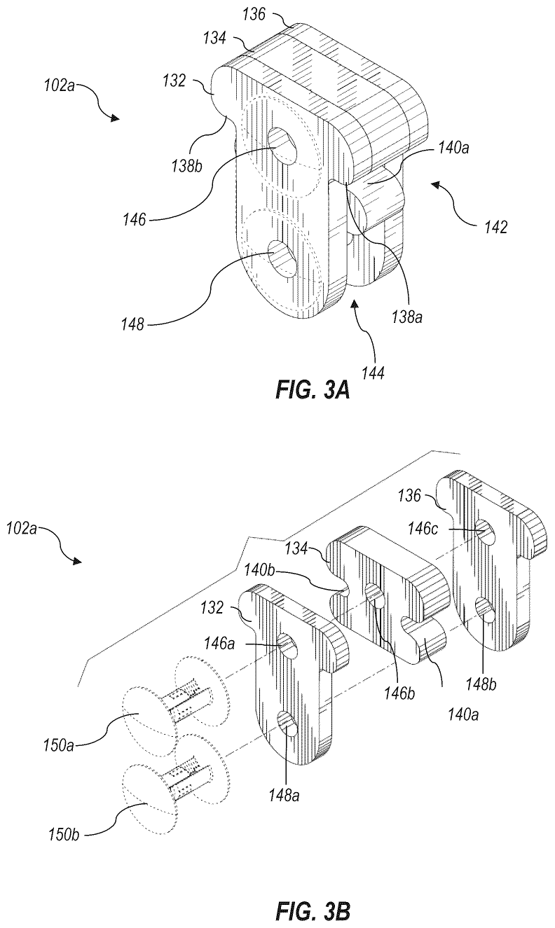

FIG. 3A illustrates a perspective view of coupling element 102a. Coupling element 102a can be the same or substantially similar to coupling element 102. Coupling element 102a can have a first body member 132, a second body member 134, and a third body member 136. Each body member can be constructed from a felt material. In another embodiment, each body member can be a metal, polymer, or similar material. First body member 132 and second body member 134 can be substantially similar in their dimensions and can have a T-shaped appearance. The first, second, and third body members 132, 134, and 136 can define a first upper contact surface 138a and a second upper contact surface 138b. The second body member 134 can also define the first lower contact surface 140a and the second lower contact surface 140b (see FIG. 3B). A first channel 142 is defined by the space between the first upper contact surface 138a and the first lower contact surface 140a. A second channel (not visible) is similarly formed by the space between the second upper contact surface 138b and the second lower contact surface 140a (see FIG. 140b). As with coupling element 102, coupling element 102a can be configured to secure or lock into a strut (such as strut 104) using channel 142.

FIG. 3A also shows that the lower region of the first and second body members 132 and 136 can act as a first arm and a second arm similar to the first and second arms of coupling element 102. Thus, the lower portions of the first body member 132 and the second body member 136 define a receiving slot 144. An assembler can insert a portion of a baffle into receiving slot 144 to secure the coupling element to the baffle. An assembler can install a baffle having the same thickness as the thickness of the second body member of a given embodiment. The multi-body design of the coupling element is advantageous in allowing for the removal and replacement of the second body member with a different second body member of a different thickness, providing modularity to coupling element 102a. An assembler can remove fastener 150a (see FIG. 3B) and replace the second body member depending on the thickness of the baffle being hung or coupled by the assembler.

FIG. 3B shows coupling element 102a can also include one or more apertures 146 and 148. In at least one implementation, all apertures 146a, 146b, and 146c (found on the first, second, and third body members 132, 134, 136) can align to allow fastener 150a (see FIG. 3B) to pass through coupling element 102a and to secure the first, second and third body members 132, 134, 136 together. Similarly, all apertures 148a and 148b (found on the first and third body members 132 and 136) can align to allow for fastener 150b (see FIG. 3B) to pass through and to couple a baffle to the coupling element.

An assembler will appreciate the lightweight and strong construction of coupling element 102a. Coupling element 102a, as with any coupling element of the present disclosure, provides a way for mounting or securing baffling or paneling without the need for tools to existing or conventional struts.

FIG. 3B illustrates an exploded view of coupling element 102a. As previously discussed, fastener 150a can be configured to secure the body members together, and fastener 150b can be configured to secure a baffle to the coupling element. Fasteners 150a and 150b can be identical. FIG. 3B also shows the relative dimensions of each of the body members. The T-shape form of first body member 132 and third body member 136 can be seen.

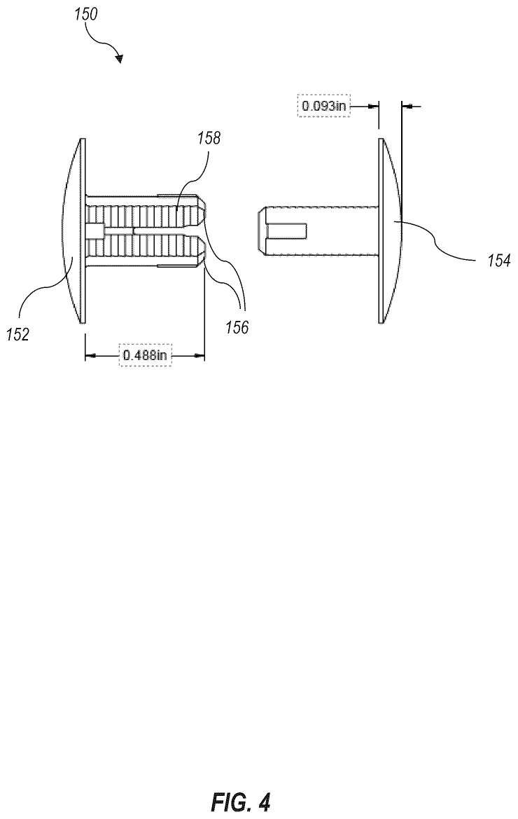

FIG. 4 illustrates fastener 150. Fastener 150 can have two halves, 152 and 154. Half 152 can be substantially identical to half 154, or it can be complementary in nature. This can mean that half 152 and half 154 interlock with each other through one or more arms 156 and teeth 158. Each half (152 and 158) can have one or more arms 156. Each arm can have one or more teeth 158. The fasteners of the present disclosure allow coupling without using tools. For example, an assembler can insert half 152 through one side of a coupling element and an inserted baffle. The assembler can then insert half 154 through the opposing side of the coupling element and the inserted baffle. By pushing half 154 and 158 together, an assembler can cause the teeth 158 on both halves to interlock or clip together. As previously discussed, fasteners of the present disclosure can secure a multipart coupling element or a baffle/panel to a coupling element together.

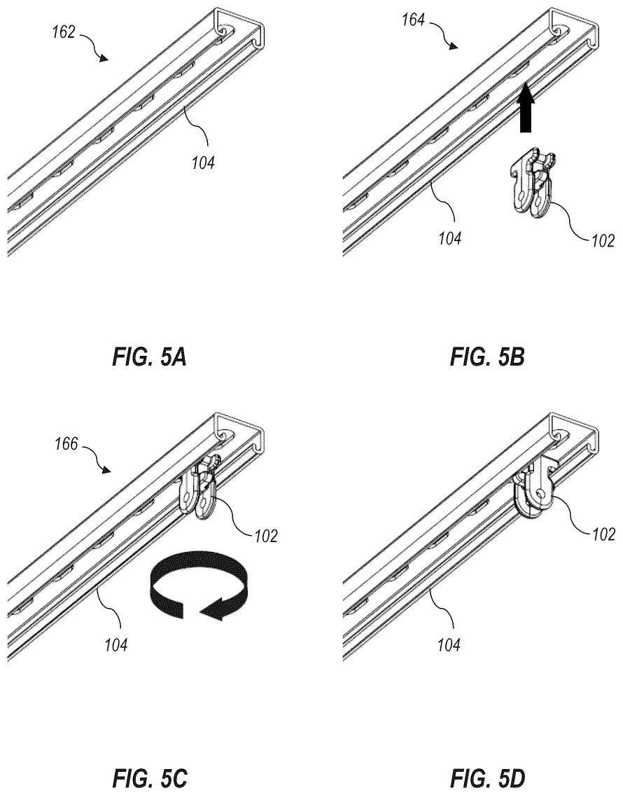

FIGS. 5A-5D illustrate sequential schematics of installing a coupling element 102 onto a strut, such as the illustrated strut 104. For example, FIG. 5A illustrates a first act 162, which comprises providing one or more struts. Act 162 can include using a pre-existing strut system or installing a strut. In one example, an assembler can secure a cable to either end (or somewhere along the length of the strut) and anchor the opposing end into a wall, ceiling, or similar surface. The assembler can alternately connect the strut 104 directly to a support surface, such as a ceiling or wall. Once anchored, an assembler can also level the strut 104 as needed.

FIG. 5B shows that act 164 includes inserting a coupling element into the strut. Act 164 can include inserting a first coupling element that is oriented about 90 degrees off of a locked orientation into a space defined by the arms of a strut. FIG. 5B illustrates a coupling element that is oriented 90 degrees off of a locked orientation. An assembler can insert coupling element 102 such that the top surface is received between the arms of strut 104.

FIG. 5C shows that Act 166 can include rotating and or locking coupling element 102. In particular, Act 166 can include rotating the first coupling element about 90 degrees (about a vertical axis) to secure the coupling element within the strut. Along these lines, FIGS. 5C and 5D illustrate the rotation of coupling element 102. Through rotating coupling element 102, the channels of coupling element 102 are forced to abut, interface, or come in contact with the arms of strut 104. The angled nature and dimension of the channels ensure a firm friction-based connection between coupling element 102 and strut 104.

An assembler can slide coupling element 102 along the length of strut 104 as the coupling between coupling element 102 and strut 104 is simply a friction or pressure-based fit. Thus, an assembler only has to overcome the friction or pressure between the coupling element and the strut to urge the coupling element back and forth along the length of the strut.

FIG. 5D shows coupling element 102 in a locked orientation. An assembler can use a guide, gauge, aid, spacer, or separating tool to help align the next coupling element along the length of strut 104. For example, an assembler can use a 4-inch spacer to ensure there are 4 inches between coupling element 102 and a second coupling element. The assembler can then repeat the process along the desired length of the strut and perform similar acts along a second or additional strut.

FIGS. 6A-6D illustrate sequential schematics of installing a baffle to a coupling element of the present disclosure. For example, FIG. 6A illustrates Act 172. Act 172 can comprise providing a coupling element secured to a strut and a baffle. Act 172 can include aligning a baffle 106 with a coupling element 102 that is secured to a strut 104. As previously described, an assembler can align an index of baffle 106 with the receiving slot of coupling element 102. As illustrated in FIG. 6B, a plurality of coupling elements have been secured into strut 104.

Act 174 can comprise inserting a baffle 106 into a coupling element 174. Act 174 can include inserting the first end 177 of baffle 106 into a receiving slot defined by the first and second arm of the coupling element 102 (a receiving slot 128 can be seen in more detail in FIGS. 2A and 2C). A portion of strut 104 can be retained within index 173 during Act 174. A user will appreciate index 173, seen in FIG. 6A, of baffle 106 as it can receive baffle 106 so that it is positioned higher and closer towards the strut 104, providing a much cleaner and aesthetically pleasing look. In other words, the index can remove the space between the baffle and the struts.

Act 176 can comprise inserting a fastener into the baffle and coupling element. FIG. 6C also shows magnified view 177, a magnified view of Act 176 showing the interrelation between the components during the insertions. Act 176 can include inserting the first half of a fastener (152) into a first aperture in the first arm, an opening in the baffle, and a second aperture in the second arm and inserting a second half of the fastener (154) into the second aperture in the second arm, the opening 175 in the baffle, and the first aperture in the first arm. As previously discussed, an assembler can push or urge the two halves (152 and 154) together to cause them to couple with each other. This coupling, in turn, secures the baffle to the coupling element.

FIG. 6D shows a baffle 106 secured to the coupling element 102, which is coupled to or secured to strut 104. An assembler can then follow the above-described acts for additional baffles or for the opposing side of the same baffles.

FIG. 7 illustrates baffle 106a. Baffle 106a can include an upper portion 192, a lower portion 190, one or more indexes 198, and one or more openings 200. Upper portion 192 and lower portion 190 can have a hinged relationship. This means a manufacturer can couple the upper and lower portions (192 and 190) together with elastics, fabrics, hinges, or similar bendable materials. A manufacturer can also score or cut the baffle and provide a notch that enables the bending of the baffle (see FIG. 7) rather than coupling two pieces together. The folding or angling can occur along seam 204.

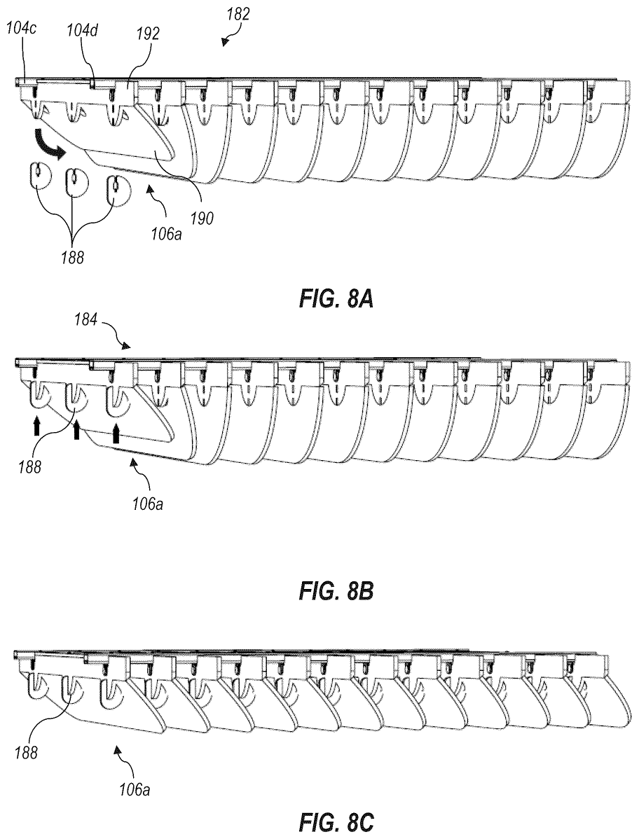

FIG. 7 shows that tabs 194 can be disposed along and define part of seam 204. This allows tabs 194 to stick out from the baffle when an assembler folds back or angles lower portion 190. Tab 194 can include one or more recesses 202 on either of its faces. Recesses 202 can be a partial indentation into the surface of the tab that can be used to interface with the teeth of a puck (see FIGS. 8B and 8C). In at least one embodiment, recesses 202 can be apertures that pass through the entire thickness of tab 191. Each tab 194 can have one or more recesses 202 on each face, or it can have no recesses. For example, if no recesses 202 are present, a puck can be friction fit to the tab. A manufacturer can construct a baffle to have one or more tabs. Tab 194 can be constructed into various geometric or non-geometric shapes.

FIG. 7 shows indexes 198 and opening 200. Indexes 198 can be cutouts or spaces along the top edge of a baffle of the present disclosure that allows for a baffle to form around a coupling element and a strut. A baffle with no index could leave a space between the struts and the baffles of a given system. Openings 200 can be a hole or aperture that extends through the entire thickness of a baffle. A manufacturer can configure opening 200 to be the same size or similar size to the apertures of a coupling element to facilitate the insertion of a fastener of the present disclosure.

FIGS. 8A-8C illustrate sequential schematics of angling or folding a baffle of the present disclosure. A user can implement the present disclosure to achieve a system of angled or sloped baffles. For example, an assembler can perform acts 182 and 184 to structurally angle one or more baffles 106a such that the baffles maintain their angled orientation to provide a user with a specific aesthetic or functional pattern. Act 184 can comprise angling a lower portion 190 of baffle 106a relative to an upper portion 192. Act 184 can include an assembler bending back, folding, or rotating the lower portion of the baffle relative to the upper portion, as shown in FIG. 8A. Baffle 106a can be secured to struts 104c and 104d.

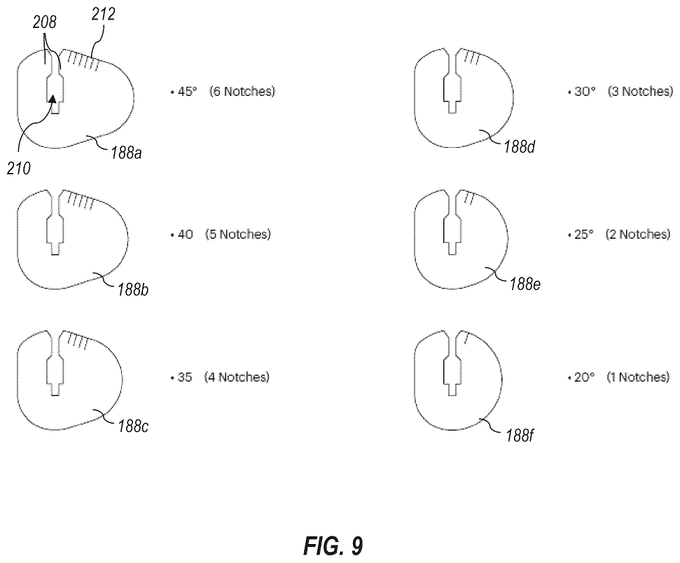

Act 184 can comprise coupling or securing one or more pucks to baffle 106a. Act 184 can include friction fitting, press fitting, or sliding a puck 184 over a baffle tab. As seen in FIG. 9, pucks of the present disclosure can define a predefined angle based on their dimensions. An assembler can ensure that the teeth of puck 188 (see FIG. 9) interface with the recesses on the face of the tab (see FIG. 7). The teeth interfacing with the recesses of the tab allows for the coupling of a puck to the tab to be more than a friction fit but rather a clipped or interrelated fit (see FIG. 9 for details of teeth 210). An assembler can then perform the same puck-to-tab connection for the remaining baffles on a given system. In at least one embodiment, the baffles can be angled to various and different predetermined angles to form a desired overall shape for the system. For example, an assembler can angle the baffles of a 12-baffle system as follows: 45 degrees, 40 degrees, 35 degrees, 30 degrees, 25 degrees, 20 degrees, 20 degrees, 25 degrees, 30 degrees, 35 degrees, 40 degrees, 45 degrees. This would provide a user with a wave or rounded overall shape to their baffle system.

FIG. 8C illustrates a fully assembled and angled baffle system of the present disclosure. Each baffle 106a has been angled similarly using the same puck 188 on every tab.

FIG. 9 illustrates various pucks (188a, 188b, 188c, 188d, 188e, and 188f) of the present disclosure. Each illustrated puck 188(a-f) can have one or more teeth 208, channel 210, and a support surface 212. As previously discussed, channel 210 can receive a baffle, i.e. an assembler can fit a puck around the thickness of the baffle wherein the baffle is inserted into channel 210. Teeth 208 can interrelate or clip into the recesses of a tab. Support surface 212 defines an angle. FIG. 9 shows that each puck (188a, 188b, 188c, 188d, 188e, and 188f) has a predefined angle (45 degrees, 40 degrees, 35 degrees, 30 degrees, 25 degrees, 20 degrees). A manufacturer can design a puck to support any angle (from 90 degrees to about 0 degrees) along its support surface. For example, a support surface with a 90 degree angle will cause a baffle to have its upper and lower surfaces to form a 90 degree angle. A manufacturer can notch the support surface to indicate the predefined angle of the puck.

Accordingly, one will appreciate in view of the specification and claims that the present disclosure teaches coupling elements, baffles, pucks, and the devices, system, and methods that they can be used in. Assemblers of this system will greatly value its tool-less installation process, which significantly reduces the time and effort typically required for assembly. The intuitive design of the coupling elements and baffle coupling systems eliminates the need for specialized and expensive tools, making it accessible to a wide range of users and minimizing labor costs. Its adjustability further enhances usability, allowing for precise alignment and seamless integration into various configurations, whether in linear arrangements or creative, angled layouts.

Additionally, the cost-effective mounting solution not only streamlines installation but also reduces material and hardware expenses for a user, ensuring that the system delivers both functional and economic advantages. This combination of ease, flexibility, and affordability makes the coupling elements and baffle coupling systems an ideal choice for efficient and versatile assembly. The coupling elements and baffle coupling systems also provide a user with an aesthetic and easily customized end product that can be cheaper than other conventional bespoke baffle or panel system.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A coupling element comprising:
a first upper contact surface and a second upper contact surface;
a first lower contact surface and a second lower contact surface; and
a receiving slot defined by a first arm having a first aperture and a second arm having a second aperture;
wherein:
the first upper contact surface and the first lower contact surface define a first channel, and
the second upper contact surface and the second lower contact surface define a second channel.

2. The coupling element of claim 1, further comprising a third upper contact surface and a fourth upper contact surface.

3. The coupling element of claim 1, wherein the coupling element is defined by a first body member, a second body member and, a third body member wherein the second body member is secured between the first body member and the third body member with a fastener.

4. The coupling element of claim 3, wherein the first body member, the second body member, and the third body member are constructed from a felt material.

5. The coupling element of claim 1, wherein the first and second lower contact surfaces are angled to relative to a horizontal plane.

6. The coupling element of claim 1, wherein the first and second lower contact surfaces are configured to plastically deform during an installation.

7. The coupling element of claim 1, further comprising a threaded connector disposed on a top side of the coupling element.

8. The coupling element of claim 1, wherein the first aperture and second aperture align to allow for a substantially linear fastener to pass through both the first aperture and second aperture.

9. The coupling element of claim 1, wherein the first upper contact surface does not vertically align with the first lower contact surface.

10. The coupling element of claim 1, wherein the first channel and second channel are substantially perpendicular to the receiving slot.

11. A couplable baffle comprising:
a coupling element comprises a receiving slot defined by a first arm having a first aperture and a second arm having a second aperture;
a baffle having a first index and an opening; and
a fastener having a first member selectively couplable with a second member;
wherein:
the receiving slot is configured to interface with the first index,
the baffle is configured to recess within the receiving slot, and
the fastener is configured to pass through the first aperture, the second aperture, and the opening to secure the baffle to the coupling element.

12. The coupling element of claim 11, wherein the baffle comprises a joint configured to facilitate angling a lower portion of the baffle relative to a top portion of the baffle.

13. The coupling element of claim 12, further comprising a puck defining a channel and one or more teeth configured to couple with one or more recesses on a tab of the baffle.

14. The coupling element of claim 13, wherein the puck comprises an angled support surface that defines an angle of the lower portion of the baffle relative to the top portion of the baffle.

15. A baffle coupling system comprising:
one or more coupling elements;
one or more baffles; and
one or more struts;
wherein:
a first of the one or more coupling elements selectively and rotatably secures to a first of the one or more struts,
the first coupling element selectively couples to a first of the one or more baffles, and
the first strut is coupled to a surface.

16. The baffle coupling system of claim 15, further comprising one or more fasteners having a first half and a second half, wherein the one or more fasteners secure the one or more coupling elements to the one or more baffles.

17. The baffle coupling system of claim 15, wherein the first coupling element can slide along the strut after being rotatably secured.

18. The baffle coupling system of claim 15, wherein each of the one or more baffles has a first index and wherein a receiving slot of the first coupling element interfaces with the baffle at the first index.

19. The baffle coupling system of claim 15, wherein the first baffle has a first angle and a second baffle has a second angle, wherein the first angle is not the same as the second angle.

20. A method for installing a baffle coupling system comprising:
inserting a first coupling element into a space defined by the arms of a strut;
rotating the first coupling element about a vertical axis into a locked orientation to secure the coupling element within the strut;
inserting a first end of a baffle into a receiving slot defined by a first and second arm of the first coupling element;
inserting a first half of a fastener into a first aperture in the first arm, an opening in the baffle, and a second aperture in the second arm;
inserting a second half of the fastener into the second aperture in the second arm, the opening in the baffle, and the first aperture in the first arm; and
coupling the first half of the fastener and the second half of the fastener together.
